(19) United States
(12) Patent Application Publication
(10) Pub. No.: US 2009/0237865 A1
(43) Pub. Date: Sep. 24, 2009

(54) SOLID ELECTROLYTIC CAPACITOR AND METHOD FOR MANUFACTURING SAME

(75) Inventors: Eiji Komazawa, Tokyo (JP); Hirokazu Murakoshi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Tokyo (JP)

(21) Appl. No.: 12/092,375

(22) PCT Filed: Oct. 31, 2006
(86) PCT No.: PCT/JP2006/321743

§ 371 Date: May 1, 2008

Related U.S. Application Data
(60) Provisional application No. 60/734,782, filed on Nov. 9, 2005.

(30) Foreign Application Priority Data
Nov. 1, 2005 (JP) 2005-318244
Sep. 1, 2006 (JP) 2006-237482

(51) Int. Cl. H01G 9/15; H01G 9/012; H01G 9/08

(52) U.S. Cl. 361/528; 29/25.03; 361/540; 361/435

(57) ABSTRACT

The invention relates to a solid electrolytic capacitor, obtained by bonding a capacitor element to a lead frame, especially a lead frame having a partial plating of low-melting point metal which is provided by applying taping on some part of the lead frame. The solid electrolytic capacitor of the invention is excellent in heat resistance and has high degree of completion of resin encapsulation, which contributes to its excellent moisture resistance. Also, since a lead frame with low-melting point metal plating can be used, no further plating process is required and in case of using resistance welding method, a solid electrolytic capacitor can be obtained easily through anodic bonding in stacking elements.

### CROSS-REFERENCE TO THE RELATED APPLICATIONS

This is an application filed pursuant to 35 U.S.C. Section 111(a) with claiming the benefit of U.S. Provisional application Ser. No. 60/734,782 filed Nov. 9, 2005, under the provision of 35 U.S.C. Section 111(b), pursuant to 35 U.S.C. Section 119(e) (1).

### TECHNICAL FIELD

The present invention relates to a capacitor and a production method thereof, in particular, relates to a solid electrolytic capacitor and a production method thereof. More specifically, the invention relates to a solid electrolytic capacitor which consists of a capacitor element comprising a solid electrolyte layer provided on a valve-action metal substrate having a dielectric film and a lead wire (lead frame) provided thereto, wherein connection of the capacitor element and the lead frame is excellent in strength and heat resistance, which leads to high reliability of the solid electrolytic capacitor.

### BACKGROUND ART

In line with recent trends toward downsizing and digitalization for power energy saving and the like in electronic devices and toward increasing speed of personal computers, capacitors have been downsized and increased in capacitance. There is an increasing demand for capacitors having a reduced impedance at high-frequency as well as large capacitance and high reliability. As capacitors meeting such a demand, solid electrolytic capacitors are in practical use.

Generally, a solid electrolytic capacitor has a basic structure obtained as follows: a dielectric oxide film is formed on surface of an etched valve-action metal such as aluminum, tantalum and titanium; a solid electrolyte layer consisting of an organic layer such as electroconductive polymer or an inorganic layer such as metal oxide is formed on the dielectric oxide film to thereby form a single capacitor element; two or more of such a capacitor element are stacked; an anode lead wire is connected to an anode terminal of the valve-action metal (an end part of the valve-action metal surface on which part no solid electrolyte is formed); a cathode lead wire is connected to the electroconductive layer (cathode part) consisting of the solid electrolyte; and the whole is encapsulated with insulative resin such as epoxy resin. As the anode lead part and the cathode lead part, a lead frame having a shape suitable for placing a capacitor element or a stack of capacitor elements thereon can be employed.

In order to produce a highly reliable product as a solid electrolytic capacitor having such a structure, it is necessary to enhance not only strength of connection between capacitor elements and the lead frame but also heat resistance. For this purpose, in conventional solid electrolytic capacitors, for example, in a case where a lead frame made of copper or copper alloy is bonded to an end part of an anode part of a capacitor element, electroconductive adhesive agent is used, alternatively they are mechanically bonded by bending the terminal and tightening together or by welding with lead-based solder material or with laser.

These bonding methods using electroconductive adhesive agents, however, involve time for applying the adhesive agent, and especially in a case where many capacitor elements are stacked and bonded, the bonding procedure is complicated. In the method where the bonding part is mechanically bonded by tightening, the method is not suitable and the bonding becomes unstable in a case where the bonding part is small in size. Moreover, in the method using lead-based solder material, there is a concern that excessive lead removed from the bonding portion may cause environmental pollution. The method using laser-welding involves a problem of high costs for equipment.

In addition to the above bonding methods, a method where a terminal of a capacitor element is resistance-welded to a lead frame is known (Patent Document 1: Japanese Patent Application Laid-Open No. H03-188614). In this resistance-welding method, the material for the lead frame is limited to iron-nickel alloy (42 alloy). Moreover, in a case where aluminum foil is used as valve-action metal in the capacitor element, a lead frame made of copper, copper alloy or the like cannot be bonded simply by resistance-welding. Resistance welding is a method of bonding metals by melting the bonding parts of the metals with heat generated through electric resistance (Joule heat). In materials having high electroconductivity such as aluminum, copper and copper alloy, the resistance is low and heat generation is small and further, since thermal conductivity is high, the part to be bonded cannot be melted sufficiently. Accordingly, it is difficult to bond these materials in such a method.

Moreover, as conventional solid electrolytic capacitors, those consisting of a lead frame having plating on the whole surface and capacitor elements bonded thereto are known. In a case where capacitor elements are stacked on the lead frame the whole surface of which is plated and then are heat-treated, there is a concern that when part of the lead frame is disengaged from the bonding with the capacitor elements and contacts with molding resin, plating metal is molten to generate defects called solder balls. There is a known structure where in order to prevent such a disadvantage, after applying a solder plating onto the whole surface of the copper base material of the lead frame, the plating is removed in parts which contact with molding resin to thereby expose the copper base and roughen the surface, then capacitor elements are placed and bonded onto the roughened surface (Patent Document 2: Japanese Patent Application Laid-Open No. H05-21290). In this approach, however, there is a problem that the amount of the plating on the bonding portion of capacitor elements is insufficient to thereby reduce bonding strength.

In terms of bonding structure in a solid electrolytic capacitor, in a case where capacitor elements and a lead frame are bonded by welding, the lead frame surface in parts which contact with molding resin in resin-encapsulated part of the lead frame is not plated, but the part of the lead frame which contacts with capacitor elements is plated with metal having low melting point, so that bonding strength can be high without generating defects such as solder ball. In terms of bonding structure of the anode part, a solid electrolytic capacitor having a bonding structure in which anode parts of capacitor elements and the lead frame are designed to be bonded by resistance welding through easy operations and which causes no environmental pollution has been disclosed (Patent Document 3: International Publication No. WO00/74091 pamphlet (U.S. Pat. No. 6,661,645)). In this method, however, although bonding strength is remarkably improved by employing partial plating of the lead frame, the method is not necessarily simple one on industrial scale since a lead frame is usually subjected to continuous plating with the lead frame being wound like a coil.

Generation of solder balls is not limited to the time of encapsulating with resin. For example, it is known that when a chip-type electronic part mounted on a circuit board is heated to thereby increase the temperature inside the electronic part in a reflow-heating process and solder plating on the lead terminal surface inside the electronic part is melted, solder balls are formed and goes outside the electronic part (Patent Document 4: Japanese Patent Application Laid-Open No. H08-153651). In Patent Document 4, a solder plating layer having a thickness of 1 μm or less is formed on surface of the lead terminal before encapsulation with molding resin. An electronic device element is connected to the lead terminal and then the whole is encapsulated with molding resin. By forming a solder plating layer thicker than the solder plating layer inside the encapsulation only on surface of the lead terminal leading out of the molding resin, the problem is solved in the document.

[Patent Document 1]

Japanese Patent Application Laid-Open No. H03-188614

[Patent Document 2]

Japanese Patent Application Laid-Open No. H05-21290

[Patent Document 3]

International Publication No. 00/74091 pamphlet

[Patent Document 4]

Japanese Patent Application Laid-Open No. HO8-153651

### DISCLOSURE OF INVENTION

### Problems to be Solved by Invention

The object of the present invention is to provide a solid electrolytic capacitor produced by providing a capacitor element consisting of a valve-action metal substrate having a dielectric film thereon with a lead wire (a lead frame), which capacitor is excellent in strength of the bonding portion between the capacitor element and the lead frame, can be easily produced on industrial scale without generating solder balls due to melting of plating present on metal members in steps such as encapsulation and reflow heating, and is highly reliable, and a production method thereof.

### Means for Solving the Problems

As a result of intensive studies with a view to achieving the object, the present inventors have found out that by masking the lead frame with a material like tape in a belt-like manner, a region containing a plating layer of metal having a low melting point and a region not containing a plating layer of metal having a low melting point can be separately provided, which enables industrial-scale production of a solid electrolytic capacitor excellent in moisture resistance and highly reliable without generating defects due to melting with heat, and thus have completed the present invention.

That is, the present invention relates to a solid electrolytic capacitor and a production method thereof as follows and relates to patterning of a plating layer having a low melting point on a lead frame.

1. A solid electrolytic capacitor, which is obtained by bonding an anode part of a capacitor having the anode part and a cathode part separated from each other by an insulating layer present therebetween to a first metal member, bonding the cathode part to a second metal member and then encapsulating the whole with resin with each of the metal members being exposed in part, wherein the first and/or the second metal members have a region containing a plating layer of low melting point metal and a region not containing a plating layer of low melting point metal according to a predetermined patterning.
2. The solid electrolytic capacitor according to 1, comprising a capacitor element (8) or a stack of capacitor elements (15) each having a structure in which: one end of a substrate (1) made of a valve-action metal having a dielectric film layer (2) serves as an anode part (6); an insulating layer (3) of a predetermined width bordering on the anode part is provided on the substrate (1) in a belt-like manner to serve as an insulator; and a solid electrolyte layer (4) and an electroconductive layer (5) to serve as a cathode part (7) are stacked sequentially on the dielectric film layer except on the area of the anode part (6) and the insulator, which capacitor element(s) contacts with the lead frame (10) (11), wherein by applying a belt-like masking to the lead frame (10) (11) except for portion (23) or except for portions (23) and (24) which contact with capacitor elements, the lead frame (10) (11) contacting with the resin (28) are not plated with metal having a low melting point while only the portion (23) or the portions (23) and (24) of the lead frame (10) (11) are plated with metal having a low melting point, and wherein the lead frame (10) (11) is bonded to the anode part (6) and the cathode part (7) of the capacitor element(s) (8) or (15) and the whole is encapsulated with the resin (28).
3. The solid electrolytic capacitor according to 2, wherein the anode part (6) of the capacitor element(s)(8) or (15) is superposed on the low-melting-point-metal plating on the surface (23) of the lead frame (10) on the anode side and then resistance-welded to be bonded through resistance heat of the dielectric film.
4. The solid electrolytic capacitor according to 2, wherein in bonding the capacitor element(s)(8) or (15) to the portions (23) and (24) of the lead frame (10) (11), the anode part (6) of the capacitor element(s)(8) or (15) is superposed on the low-melting-point-metal plating on the portion (23) of the lead frame (10) on the anode side and is resistance-welded while the bonding of the cathode side is carried out with a distance (t) being provided between the end part (3a) of the insulating layer (3) on the cathode side of the capacitor element(s)(8) or (15) and the edge (11a) on the cathode side of the lead frame.
5. The solid electrolytic capacitor according to 1, comprising a capacitor element (8) or a stack of capacitor elements (15) each having a structure in which: one end of a substrate (1) made of a valve-action metal having a dielectric film layer (2) serves as an anode part (6); an insulating layer (3) of a predetermined width bordering on the anode part is provided on the substrate (1) in a belt-like manner to serve as an insulator; and a solid electrolyte layer (4) and an electroconductive layer (5) to serve as a cathode part (7) are stacked sequentially on the dielectric film layer except on the area of the anode part (6) and the insulator, which capacitor element(s) contacts with the lead frame (10) (11), wherein by applying a belt-like masking to the lead frame (10) (11) except for portion (23′) or except for portions (23′) and (24′) which contact with capacitor elements, the lead frame (10) (11) contacting with the resin (28) are not plated with metal having a low melting point while only the portion (23′) or the portions (23′) and (24′) of the lead frame (10) (11) are plated with metal having a low melting point, and wherein the lead frame (10) (11) is bonded to the anode part (6) and the cathode part (7) of the capacitor element(s)(8) or (15) and the whole is encapsulated with the resin (28).
6. The solid electrolytic capacitor according to 5, wherein the anode part (6) of the capacitor element(s)(8) or (15) is superposed on the low-melting-point-metal plating on the surface (23′) of the lead frame (10) on the anode side and then resistance-welded to be bonded through resistance heat of the dielectric film.
7. The solid electrolytic capacitor according to 5, wherein in bonding the capacitor element(s) (8) or (15) to the portions (23′) and (24′) of the lead frame (10) (11), the anode part of the capacitor element(s) (8) or (15) is superposed on the low-melting-point-metal plating on the portion (23′) of the lead frame (10) on the anode side and is resistance-welded while the bonding of the cathode side is carried out with a distance (t) being provided between the end part (3a) of the insulating layer (3) on the cathode side of the capacitor element(s) (8) or (15) and the edge (11a) on the cathode side of the lead frame
8. A solid electrolytic, which is obtained by bonding an anode part of a capacitor having the anode part and a cathode part separated from each other by an insulating layer present therebetween to a first metal member, bonding the cathode part to a second metal member and then encapsulating the whole with resin with each of the metal members being exposed in part, wherein the portion of the second metal member bonding to the cathode part has a region containing a plating layer of low melting point metal and a region not containing a plating layer of low melting point metal, and the region not containing a low-melting-point-metal plating layer is a portion bonding to the cathode part near the position at which the second metal material is led out of the encapsulating resin.
9. The solid electrolytic capacitor according to 8, wherein part of the cathode part is superposed on and bonded to the second metal member to be electrically conducting to each other.
10. The solid electrolytic capacitor according to 8 or 9, comprising a capacitor element having an insulating layer of metal oxide, a solid electrolyte layer and an electroconductive paste layer sequentially formed at least on a part of the valve-action metal surface having a porous layer on the surface, wherein the exposed part of the valve-action metal serves as an anode part and the electroconductive paste layer serves as a cathode part.
11. The solid electrolytic capacitor according to any one of 1 to 10, wherein the valve-action metal is selected from a group consisting of aluminum, tantalum, titanium, niobium and alloys thereof.
12. The solid electrolytic capacitor according to any one of 1 to 11, wherein the lead frame (10) (11) consist of copper or a copper alloy (copper-based material) or a material having plating of a copper-based material or zinc-based material.
13. The solid electrolytic capacitor according to any one of 1 to 12, wherein the low-melting-point-metal plating consists of a metal or an alloy having a melting point lower than that of the valve-action metal and the thickness of the plating is within 0.1 to 100 μm.
14. The solid electrolytic capacitor according to any one of 1 to 13, wherein the low-melting-point-metal plating consists of a base plating of nickel and a surface plating of tin.
15. The solid electrolytic capacitor according to any one of 1 to 14, wherein the position of bonding the lead frame (10) (11) is in the middle part or periphery of the stacked capacitor elements.
16. A method for producing a solid electrolytic capacitor, comprising
a step of providing an insulating layer (3) of a predetermined width in a belt like manner bordering an anode part (6) which is one end part of a valve-action metal substrate (1) having a dielectric film layer (2), a step of forming a single capacitor element (8) by providing a solid electrolyte layer (4) on the dielectric film layer except on the area of the anode part (6) and the insulating part and further stacking an electroconductive layer (5) thereon to be a cathode part (7) or forming a stack of two or more of the thus obtained capacitor elements (15), a step of bonding a lead frame (10) (11) to the anode part (6) and the cathode part (7) of capacitor element(s)(8) (15) after applying a belt-like masking onto the lead frame (10) (11) except for the portion (23) or except for portions (23) and (24) which contact with the capacitor element(s)(8) (15) so that in the part (20) encapsulated with resin, low-melting-point-metal plating is not provided on portions of the lead frame (10) (11) which contact with the resin (28) while low-melting-point-metal plating is provided on the portion (23) or portions (23) and (24), and a step of encapsulating the whole with resin.
17. A lead frame (10) (11), which is bonded to an anode part (6) and cathode part (7) of capacitor element(s)(8) (15) obtained by a step of providing an insulating layer (3) of a predetermined width in a belt like manner bordering an anode part (6) which is one end part of a valve-action metal substrate (1) having a dielectric film layer (2), wherein in the lead frame, a belt-like masking is applied except for the portion (23) or except for portions (23) and (24) which contact with the capacitor element (8) or stacked capacitor elements (15) each having a cathode part (7) consisting of a solid electrolyte layer (4) and an electrically conductive layer (5) stacked sequentially on the dielectric film layer of the region excluding the anode part and insulating part, so that in the part (20) encapsulated with resin (28), low-melting-point-metal plating is not provided on portions of the lead frame (10) (11) which contact with the resin (28) while low-melting-point-metal plating is provided only on the portion (23) or portions (23) and (24).
18. The lead frame (10) (11) according to 17, wherein the lead frame bonded to the anode part (6) and the cathode part (7) of the capacitor element(s)(8) (15) encapsulated with the resin (28) comprises a material of copper or a copper alloy (copper-based material) or a material plated with a copper-based material or zinc-based material on the surface.
19. A method for producing a solid electrolytic capacitor, comprising a step of providing an insulating layer (3) of a predetermined width in a belt like manner bordering an anode part (6) which is one end part of a valve-action metal substrate (1) having a dielectric film layer (2), a step of forming a single capacitor element (8) by providing a solid electrolyte layer (4) on the dielectric film layer except on the area of the anode part (6) and the insulating part and further stacking an electroconductive layer (5) thereon to be a cathode part (7) or forming a stack of two or more of the thus obtained capacitor elements (15), a step of bonding a lead frame (10) (11) to the anode part (6) and the cathode part (7) of capacitor element(s) (8) (15) after applying a belt-like masking onto the lead frame (10) (11) except for the portion (23′) or except for portions (23′) and (24′) which contact with the capacitor element(s) (8) (15) so that in the part (20) encapsulated with resin, low-melting-point-metal plating is not provided on portions of the lead frame (10) (11) which contact with the resin (28) while low-melting-point-metal plating is provided only on the portion (23′) or portions (23′) and (24′), and a step of encapsulating the whole with resin.
20. A lead frame (10) (11), which is bonded to an anode part (6) and cathode part (7) of capacitor element(s) (8) (15) obtained by a step of providing an insulating layer (3) of a predetermined width in a belt like manner bordering an anode part (6) which is one end part of a valve-action metal substrate (1) having a dielectric film layer (2), wherein in the lead frame, a belt-like masking is applied except for the portion (23′) or except for portions (23′) and (24′) which contact with the capacitor element (8) or stacked capacitor elements (15) each having a cathode part (7) consisting of a solid electrolyte layer (4) and an electrically conductive layer (5) stacked sequentially on the dielectric film layer of the region excluding the anode part (6) and insulating part, so that in the part (20′) encapsulated with resin(28), low-melting-point-metal plating is not provided on portions of the lead frame (10) (11) which contact with the resin (28) while low-melting-point-metal plating is provided only on the portion (23′) or portions (23′) and (24′).
21. The lead frame (10) (11) according to 20, wherein the lead frame bonded to the anode part (6) and the cathode part (7) of the capacitor element(s)(8) (15) encapsulated with the resin (28) comprises a material of copper or a copper alloy (copper-based material) or a material plated with a copper-based material or zinc-based material on the surface.
22. A method for producing a solid electrolytic capacitor, comprising a step of applying a temporary masking on part of the lead frame consisting of a first metal member and a second metal member, at least onto an area of close to the position at which the metal member is led out of resin encapsulation in the bonding portion between the second metal member and the cathode part, a step of plating the lead frame with a low melting point metal, a step of removing the temporary masking, a step of placing and bonding the anode part and the cathode part of the capacitor element onto each of the first and the second metals and bonding, and then a step of encapsulating the whole with resin.
23. The method for producing a solid electrolytic capacitor according to 22, wherein the temporary masking is in form of belt.
24. The method for producing a solid electrolytic capacitor according to 22 or 23, wherein the capacitor element consists of an insulating layer of metal oxide, a solid electrolyte layer and an electrocunductive paste layer sequentially formed at least on part of a valve-action metal surface having a porous layer on the surface, the exposed portion of the valve-action metal serving as an anode part and the electroconductive paste layer serving as the cathode part.

### Effects of Invention

When a low-melting-point-metal plating is applied and the plating is melted by reflow heat, a gap is generated between the encapsulating resin and the lead frame, which may cause deterioration in moisture resistance. According to the present invention, by ensuring bonding of the capacitor element to the metal member and preventing generation of solder balls due to melting of plating on the metal members during encapsulation or reflow heating process to thereby allow no gap to be generated by heat-melting in the resin-encapsulated portion, a highly reliable solid electrolytic capacitor excellent in moisture resistance can be produced and its industrial-scale production is easy.

Moreover, according to the present invention, the capacitor element and the lead frame can be bonded by resistance welding, and the solid electrolytic capacitor encapsulated with resin after the welding is excellent in resistance against heat and moisture and its resin encapsulation is almost flawless.

Further, according to the present invention, since a lead frame plated with a low-melting-point metal can be used, no additional plating step is required. In case of resistance welding, bonding of the anode can be easily achieved by stacking.

### BEST MODE FOR CARRYING OUT THE INVENTION

The present invention is unlimitedly applicable to any capacitors as long as the capacitor is obtained by bonding an anode part of a capacitor element having the anode part and a cathode part sandwiching an insulating layer to a first metal member, bonding the cathode part to a second metal member, and encapsulating the whole with resin such that part of each metal member is exposed. Especially, the present invention is suitable for production of a capacitor where a cathode part is placed on a second metal member and is bonded by heating or the like. A typical example of such a capacitor is a solid electrolytic capacitor comprising a capacitor element consisting of an insulating layer of metal oxide, a solid electrolyte layer and an electrocunductive paste layer sequentially formed at least on part of a valve-action metal having a porous layer on the surface, the exposed portion of the valve-action metal serving as an anode part and the electroconductive paste layer serving as the cathode part.

Hereinafter, the present invention is explained in detail by referring to drawings. In the present invention, first, an end of one side of a valve-action metal substrate having a dielectric film layer (2) on the surface is allowed to serve as the anode part (6). An insulating portion is prepared by providing, in a belt-like manner, an insulating layer (3) of a predetermined width bordering the anode part (6). On the dielectric layer except for on the anode part (6) and the insulating layer, a solid electrolyte layer (4) and an electroconductive layer (5) are sequentially stacked to serve as the cathode part (7). The thus obtained single capacitor element (8) or a stack of two or more of the capacitor elements (15) is produced.

As shown in FIG. 1, in the single capacitor element (8), an anode part (6) is prepared as an end of one side of a valve-action metal substrate having a dielectric film layer on the surface, and an insulation portion is prepared by providing on the substrate, in a belt-like manner, an insulating layer of a predetermined width bordering the anode part (6).

On the dielectric layer except for on the anode part (6) and the insulating layer, a solid electrolyte layer (4), and an electroconductive layer (5) is sequentially stacked to form a cathode part (7). The capacitor element (8) is bonded to metal members by either one of the following methods: simply the cathode and the anode parts are bonded to the metal members respectively; the cathode and the anode parts on one surface of a stack of capacitor elements (15) are bonded to the metal members respectively (FIG. 2A); or the middle part of a stack of capacitor elements (15) is bonded to the metal members (10) (FIG. 6). Then the whole is encapsulated.

### [Capacitor Element]

The substrate (1) may be selected from the valve-action metal materials which can form an oxide film, such as aluminum, tantalum, niobium, titanium, zirconium, magnesium, silicon and alloys thereof. The substrate (1) may have any shape such as etched pressure-rolled foil and sintered body of fine powder as long as it is a porous formed body. The thickness of the conductor varies depending on uses. For example, a foil having a thickness of about 40 to 300 μm is used. The size and the shape of the metal foil also vary depending on uses. In terms of a plate-shaped element unit, those rectangular foils having a width of about 1 to 50 mm and a length of about 1 to 50 mm are preferred, and more preferred are those having a width of about 2 to 15 mm and a length of about 2 to 25 mm.

As the conductor, porous sintered bodies of these metals, plates (including ribbon and foil) surface-treated by etching or the like and the like materials can be employed. Preferred are plates and foils. Moreover, as a method for forming a dielectric oxide film on the porous metal body, any known method may be employed. For example, in a case where an aluminum foil is used, an oxide film can be formed by carrying out anodic oxidation in an aqueous solution containing phosphoric acid, adipic acid or sodium salts or ammonium salts thereof. Also, in a case where a sintered body of tantalum powder is used, an oxide film is formed on the sintered body by conducting anodic oxidation in an aqueous solution containing phosphoric acid.

Generally, the above metals usable as the substrate (1) have a dielectric oxide film formed on the surface by air oxidation. It is preferred that by subjecting these metals to chemical formation treatment, formation of dielectric film be ensured.

The insulating layer (3) may be formed by spreading an insulative resin or a composition consisting of inorganic fine powder and cellulose-based resin (as described in Japanese Patent Application Laid-Open No. H11-80596) or by attaching an insulative tape. There is no limitation on insulative materials. Examples thereof include polyphenylsulfone (PPS), polyethersulfone (PES), cyanate ester resin, fluorine resin (such as tetrafluoroethylene, and copolymer of tetrafluoroethylene and perfluoroalkylvinylether), low-molecular-weight polyimide, derivatives thereof and precursors thereof, a composition consisting of soluble polyimide siloxane and epoxy resin (as described in Japanese Patent Application Laid-Open No. H08-253677 (U.S. Pat. No. 5,643,986)). Particularly preferred are low-molecular-weight polyimide, polyethersulfone, fluorine resin and precursors thereof. The method of forming the insulating layer is not questioned as long as the layer of insulative material can be formed in a predetermined width on the substrate (1).

The solid electrolyte layer (4) may be formed of any one of electroconductive polymer, electroconductive organic substance, electroconductive inorganic oxide and the like. Also, two or more kinds of materials may be formed sequentially or a mixture of two or more kinds of the materials may be formed into the solid electrolyte layer. It is preferred to use a known electroconductive polymer such as those having as repeating unit at least one of a divalent group having a structure of pyrrole, thiophene or aniline and a substituted derivative thereof. For example, a method where 3,4-ethylenedioxythiophene monomer and an oxidizing agent, preferably in form of solution, are applied separately one by one or together onto an oxide film layer of a metal foil to form solid electrolyte layer thereon (as described in Japanese Patent Application Laid-Open No. H02-15611 (U.S. Pat. No. 4,910,645), and Japanese Patent Application Laid-Open No. H10-32145 (U.S. Pat. No. 6,229,689)) can be employed.

Generally, dopant is used in electroconductive polymer. Any dopant may be used as long as the dopant has a doping ability. Examples thereof include organic sulfonic acid, inorganic sulfonic acid, organic carboxylic acid, and salts thereof. Generally, aryl-sulfonate-based dopant is used. For example, benzenesulfonic acid, toluenesulfonic acid, naphthalenesulfonic acid, anthracenesulfonic acid, anthraquinonesulfonic acid, or substituted derivatives or salts thereof can be used. As a compound leading to production of capacitors having particularly excellent properties, compounds having at least one sulfonic acid group and quinone structure in one molecule, heterocyclic sulfonic acid, anthracenemonosulfonic acid, or salts thereof may be used.

Generally, the electroconductive layer (5) is formed by spreading a carbon paste (5a) as a base and then forming a silver paste layer (5b) thereon. It may consist only of silver paste or may be formed by methods other than spreading method.

As the capacitor element, both a single capacitor element (8) and a stack of capacitor elements (15) can achieve the same effects. A stack of capacitor elements (15) is, as shown in FIG. 2A, formed by stacking two or more of capacitor element (8) (4 sheets are used in the Figure) and providing electroconductive paste (9) such as silver paste between the cathode parts (7) of the capacitor elements (8) to thereby integrally bond the elements to each other.

### [Bonding Structure of the Lead Frame on the Cathode Side]

As shown in FIGS. 2A and 2B, preferably, the solid electrolytic capacitor of the present invention has a bonding structure where, in the bonding portion between the solid electrolytic capacitor and the lead frame, a predetermined distance is provided between the end of the insulating layer on the cathode side of the capacitor element and the end part of the lead frame. That is, the edge (hla) of the lead frame on the cathode side is distanced from the insulating portion (3) of the capacitor element such that the bonding portion has a structure where the lead frame is bonded to the cathode part (7) at a predetermined position with a predetermined distance t being kept. The position of the edge (11a) of the lead frame on the cathode side (length of the distance t) may be within a range that the edge (11a) is separated from the end (3a) of the insulating layer on the cathode side by a distance equal to 1/40 the length of the cathode part (7) or longer and the maximum distance is ½ or less of the cathode part of the capacitor element. By keeping this distance t appropriately, stress concentration on or around the edge (11a) of the lead frame can be alleviated at the bonding portion on the cathode side. Moreover, excessive silver paste can be prevented from intruding the neighborhood of the dielectric layer from around the border of the insulating portion. Therefore, increase in leakage current due to reflow soldering can be prevented effectively. In order to prevent resistance of the cathode part from increasing, it is preferred that the edge (11a) of the lead frame be distanced from the end (3a) of the insulating layer on the cathode side by 1/20 or longer and ⅓ or shorter of the length of the cathode part (7), more preferably 1/10 or longer and ¼ or less of the cathode part. The length of the cathode part (7) is from the end (3a) of the insulating layer on the cathode side to the end part where the electroconductive layer (5) is formed.

As a method for placing a capacitor element on a lead frame at a precise position, it is preferable to leave marks (12) through half-etching or with laser beam at the positions on the surface of the lead frame (10) (11) where the capacitor element is placed on, as shown in FIGS. 4A and 4B. With these marks, positioning of the capacitor element can be easily carried out. The shape of the mark is not limited and any shape such as line or circle can be employed as long as the mark can indicate positions for placing the capacitor element on.

In the solid electrolytic capacitor of the present invention, it is preferable to chamfer angle parts of the edge (11a) of the lead frame on the cathode part in the plate-thickness direction, as shown in FIG. 2B. That is, angel parts are planed down a little or processed to have roundness. By processing the angles of the end of the lead frame in this way, concentration of stress on the angles of the end or the surrounding area can be further alleviated.

Moreover, a method for reducing resistance at the bonding portions of the cathode and the anode of the lead frame is not to provide a window in the lead frame, as shown in FIG. 4B. Lead frames having a window provided in advance at a predetermined position, as shown in FIG. 5, are known. After bonding the capacitor element to the lead frame, the whole body including the capacitor element is encapsulated with molding resin. The window (13) is provided for the purpose of making easier the process of bending the lead frame (10) (11) present outside of this resin at the time of forming a lead along the resin jacket. Further, by making short the outer circumference of the cross-section of the lead wire going out of the jacket resin and reducing the water amount intruding through the interface between the lead and the resin, deterioration of the capacitor element can be prevented. If a window is provided, however, the cross-section area decreases and resistance increases. By not providing the window, the resistance can be reduced. For example, by not providing the window, serial resistance value of the capacitor element can be improved by about 5%. By providing some ingenuity in forming a plating layer applied on the lead frame surface, using a water-repellent resin as a binder in the electroconductive layer constituting the capacitor element and the like technique to thereby prevent water from intruding inside the element, provision of window part on the lead frame can be omitted. Moreover, without a window, no step of shot-blast treatment for removing excessive jacket resin to clog the window is necessary and thus, an effect of shortening the production time can be obtained.

### [Bonding Structure of the Lead Frame on the Anode Side]

In a case where the lead frame (10) on the anode side is bonded to the anode part (6) of the capacitor element, the bonding portion of the lead frame on the anode side (10) used here has a low-melting-point-metal plating. On the portion having this plating thereon, the anode part (6) capacitor where the dielectric layer of the capacitor element is exposed is superposed and then resistance welding is conducted on this bonding portion. As materials for the lead frame, iron-nickel-based alloys mainly comprising iron and nickel, zinc material, copper material, copper alloys containing tin, nickel, iron or the like added thereto or the like is generally used in various types of electronic devices. The bonding method of the present invention can be widely applied to lead frames formed of these general materials. Among these, the present invention is particularly useful applied to lead frames consisting of materials having good electroconductivity such as copper or copper alloy.

There is no particular limitation on materials for the lead frame as long as the material is generally used. Preferred materials are copper-based ones (such as alloys based on Cu—Ni, Cu—Sn, Cu—Fe, Cu—Ni—Sn, Cu—Co—P, Cu—Zn—Mg, or Cu—Sn—Ni—P) and materials having the surface coated with copper-based or zinc-based plating material. By using such a preferred material, the shape of the lead frame can be devised to thereby further reduce resistance and also, an effect of improving in workability for chamfering the angle part of the edge (11a) of the lead frame end part can be obtained.

As the low-melting-point-metal plating, metals or alloys having a melting point lower than those of valve-action metals are used. Generally, silver is most frequently used as a material for plating a lead frame. Other than silver, gold, nickel, copper, tin, or solder (Sn—Pb alloy) is used. In a case where an aluminum formed foil is used as valve-action metal, tin (melting temperature: 505K), lead (melting temperature: 600K), zinc (melting temperature: 693K), alloy thereof (solder: 6Sn-4Pb), each having a melting point lower than that of aluminum (melting temperature: 933K), other fusible alloys or other soldering materials, are used for plating the lead frame. The thickness of the plating layer is formed such that the bonding strength between the valve-action metal substrate (1) serving as the anode part (6) and the lead frame can have a sufficient strength and the appropriate thickness range is from about 0.1 to 100 μm, preferably from about 1 to 50 μm. The plating layer may be superposed on a base plating.

It is preferable to use a plating metal containing little lead or little lead compound which causes environmental pollution. Preferred examples include a material having a tin plating on the surface formed on a base plating of nickel. This material does not contain lead and moreover, by plating the base nickel plating with tin, not only adhesion strength of the tin plating onto the lead frame is enhanced, but also adhesion strength between the capacitor element, the tin plating and the lead frame at the time of welding can be increased.

By resistance-welding the low-melting-point-metal plating on the lead frame (10) on the anode side and the anode part (6) of the capacitor element superposed thereon, heat is generated at the bonding portion due to intrinsic resistivity of dielectric film (2) of the anode part (6) end, whereby the plating metal on the lead frame is molten to cause integrally bonding between the lead frame (10) and the anode end part (6). Also, in a case where an aluminum formed foil is used as a substrate, the heat generated due to intrinsic resistivity of the dielectric film (2) melts the surface of the aluminum formed foil, whereby the aluminum foils stacked on the anode part combine in the surface with each other to thereby integrally be bonded.

This bonding method by resistance-welding can be applied to a case where the lead frame is bonded to the outer surface (periphery) of the stacked capacitor elements (15) as shown in FIG. 2A and to a case where the lead frame is bonded to the middle part of the stacked capacitor elements (15) as shown in FIG. 6. In the bonding structure shown in FIG. 6, the number of capacitor elements to be stacked is arbitrarily determined and the number of capacitor elements stacked in the upper direction on the lead frame may be different from the number of capacitor elements stacked on the underside of the lead frame.

The resistance welding may be practiced in accordance with ordinary working procedures. The welding conditions may be determined appropriately depending on the kind of valve-acting metal, shape of foil (thickness, dimension and so forth), number of stacked layers, material of lead frame, kind of low-melting-temperature metal, and so forth. For example, in a case where a nickel-tin plated copper lead frame is used and a stack of 4 to 8 single capacitor elements each made of about 100 μm-thick electrochemically formed aluminum foil is bonded to the lead frame, an electrode may be placed and pressed on the bonding part under a compression of about 3 to about 5 kg, while supplying energy of about 6.5 to about 11 W·s. and applying current such that a peak current is 2 to 5 kA and current application time is 1 to 10 ms according to the current application pattern of a middle pulse as shown in FIG. 7.

Patterns of applying a low-melting-point plating on the lead frame in the present invention are shown below.

### Plating Pattern 1:

In the area (20) to be encapsulated with resin(28), by masking the portions (10) (11) of the lead frame contacting the capacitor element (8) or a stack of the capacitor elements (15) or masking the portions of the lead frame except for the portion (23) or portions (23) (24) with a belt-like material such as taping material, no low-melting-point-metal plating is applied onto the portions (10) (11) of the lead frame while low-melting-point-metal plating is applied only onto the portion (23) or the portions (23) (24) of the lead frame. The portions (10) (11) of the lead frame are bonded to the anode part (6) and the cathode part (7), and the whole is encapsulated with resin to thereby produce a solid electrolytic capacitor.

In the belt-like masking step of the portions (10) (11) of the lead frame contacting the capacitor element(s)(8) (15) or the portions of the lead frame except for the portion (23) or portions (23) (24) (hereinafter, taping is explained as one example), taping is provided, in the area (20) to be encapsulated with resin (28), such that no low-melting-point-metal plating is applied onto the portions (10) (11) of the lead frame which the resin (28) contacts while low-melting-point-metal plating is applied only onto the portion (23) or the portions (23) (24) of the lead frame. There is no particular limitation on method for applying such a low-melting-point-metal plating. A stripe-plating method where the plating is provided only onto the portions that require low-melting-point-metal plating by preparing a lead frame having a taping material on it is preferred. There is no limitation on method for bonding between the lead frame and the capacitor element, and welding such as resistance welding and spot welding or adhesion with electroconductive paste may be employed. For the anode part, resistance welding is preferred while adhesion with electroconductive paste is preferred for the cathode part.

### [Bonding by Partial Plating]

The solid electrolytic capacitor of the present invention has a structure as shown in FIG. 8, in which the portions (10) and (11) of the lead frame are bonded to the capacitor element (8) (15) and in which in the portion encapsulated with resin (20), no plating is applied on the portions (21) and (22) of the lead frame which contact with the molding resin (28) while a low-melting-point plating is applied to the portions (23) and (24) of the lead frame which contact with the capacitor element (26), especially to the portion (23) contacting the anode part (6).

In this plating step, the portions (10) (11) of the lead frame contacting the capacitor element(s)(8) (15) or the portions of the lead frame except for the portion (23) or portions (23) (24) are covered with taping material. The taping material is provided, in the area (20) to be encapsulated with resin (28), such that no low-melting-point-metal plating is applied onto the portions (10) (11) of the lead frame which the resin (28) contacts while low-melting-point-metal plating is applied only onto the portion (23) or the portions (23) (24) of the lead frame. There is no particular limitation on method for applying such a low-melting-point-metal plating. A stripe-plating method where the plating is provided only onto the portions that require low-melting-point-metal plating by preparing a lead frame having a taping material on it is preferred.

In the case where a lead frame (10) (11) made of a copper-based material is used, in the area (20) to be encapsulated with resin (28), the surface of the copper-based-material-made substrate is exposed in the lead frame surface portions (21) and (22) that contact with the molding resin (28) as well as the rear surface of the lead frame (10) (11). On the other hand, low-melting-point-metal plating is provided onto the surface portions (23) and (24) where the lead frame (10) (11) contacts with the capacitor element (26), especially onto the portion (23) that contacts with the anode part (6). Examples of the low melting temperature metal plating include tin plating provided on nickel plating, and so on. In the Figures, the parts (30) and (31) are window parts (punched parts). As described above, these parts do not have to be provided. The part (32) of the lead frame outside encapsulation with the molding resin may be plated. Therefore, in the resin-encapsulated area, the portions (23) and (24) where the lead frame contacts with the capacitor element (26), especially the portion (23) contacting with the anode part (6), are plated, but the portions (21) and (22) that contact with the molding resin (28) are not plated. When necessary, the rear surface of the lead frame is stripe-plated.

As shown in FIG. 12, in the resin-encapsulated area (20), only the portion (23) or the portions (23) and (24) of the lead frame surface that intimately contact with the capacitor element (26) are plated. On the plated portions, single capacitor elements (8) are superposed. Then, on the cathode side, the cathode parts (7) of the capacitor elements are bonded to each other and the cathode part (7) is bonded to the lead frame (11), by using electroconductive paste (9). On the other hand, on the anode side, the anode parts (6) of the capacitor elements are intimately adhered to each other, and while pressing, the anode parts (6) are bonded to each other and the lower surface of the anode part (6) and the lead frame surface (23) are bonded to each other, by spot welding. Thus, a stacked-type capacitor element (26) is obtained. After the stacked capacitor element (26) is molded with a resin (28) as shown in FIGS. 13 and 14, the resin-molded capacitor element is removed from the lead frame and the portions (10) and (11) of the lead frame are bent, whereby a solid electrolytic capacitor (29) is obtained. FIG. 8 shows a structure consisting of the lead frame bonded at (10) and (11) to capacitor elements (8) (15) in which, in the resin-encapsulated area (20) of the lead frame, the portions (21) and (22) which contact with the molding resin (28) are not plated while the portions (23) and (24) at which the lead frame contacts with the capacitor element (26) are plated with low-melting-point metal. The structure may consist of the lead frame bonded at (10) and (11) to capacitor elements (8) (15) in which only the portion (23) contacting the anode part (6) is plated with low-melting-point metal.

### Plating Pattern 2:

As a metal member, for example, a lead frame having a structure continuing from side to side as shown in FIG. 10 is preferred. The lead frame integrally holds a plurality of portion (20) to be encapsulated with resin by frame portions (10), (11) and (32). The portion to be encapsulated with resin (20) includes the portion (21) bonding to the anode part of the capacitor element and the portion (24′) bonding to the cathode part of the capacitor element. As shown in FIGS. 3 and 6, the anode part (6) of the capacitor element is bonded to the bonding portion (21) and the cathode part of the capacitor element (7) is bonded to the bonding portion (24′). The structure of the present invention, as shown in FIG. 10, is characterized in that the region not having a low-melting-point-metal plating layer is the portion (25) to which the cathode part is bonded in the vicinity of the position at which the portion (24′) bonded to the cathode part of the capacitor element is led out of the encapsulating resin and is exposed. In FIG. 10, although no region not having a low-melting-point-metal plating layer is provided on the anode part, the plating structure on the anode part is not particularly limited and similarly to the anode part in FIG. 9, region not having a low-melting-point-metal plating layer may be provided on the anode side (see FIG. 11).

The portion (25) to which the cathode part is bonded in the vicinity of the position at which the portion (24′) bonded to the cathode part of the capacitor element is led out of the encapsulating resin capacitor and is exposed is a bonding portion close to the portion left outside the resin encapsulation to serve as an anode or cathode terminal. As lead frames, those of the type as shown in FIG. 10 having window parts (30) and (31) provided in advance are known. After bonding the capacitor element to the lead frame, the whole of the capacitor element is encapsulated with resin. The window parts (30) and (31) are provided in order to make it easy to bend the lead frame portions (10) and (11) projecting out of the resin in the step of forming leads along the encapsulating resin. Further, the windows are provided to prevent deterioration of the capacitor element by reducing the peripheral length of the cross-section of leads led out of the encapsulating resin to thereby reduce the amount of water intruding through the interface between the leads and the resin. According to the present invention, in the vicinity of the window parts (or the corresponding portion in a case where no window is provided), a region having no low-melting-point-metal plating layer is provided in the area bonded to the cathode part of the capacitor element.

Here, in a case where the portion (24) bonded to the cathode part of the capacitor element is rectangular, the term “vicinity” means a region within a distance of about 30% of the total length of the portion bonded to the cathode part from the position at which the lead is led out of the encapsulating resin to be exposed, although it depends on the size and shape of the capacitor element. The region not having a low-melting-point-metal plating layer may be provided in this region (the region indicated by t′ in FIG. 10) in arbitrary shape and size. In a case where the portion bonded to the cathode part assumes a rectangular shape as a whole as seen in FIG. 10, for example, the region is formed to have a band-like shape of a width of 0.5 mm or more. The region not having a low-melting-point-metal plating layer is provided such that the region contacts with the position at which the metal member is led out of the encapsulating resin to be exposed.

By designing the region not having a low-melting-point-metal plating layer in this way, generation of solder balls can be suppressed even if the capacitor element goes through encapsulation process or reflow heating. The reason why no solder ball is generated is not simply that there is no low-melting-point-metal plating layer in the vicinity of the portion at which the metal member is led out of the encapsulating resin (generally, since an inner plating layer may be molten at the time of heating, solder balls may be formed from the molten inner plating when only the vicinity of the portion has no low-melting-point-metal plating layer). For example, it can be assumed that when a region not having a low-melting-point-metal plating layer forms a depression (groove), electroconductive paste on the cathode part of the capacitor element gets in the depressed part, to thereby serve as a blocker layer which prevents the molten inner plating from flowing in.

A plating structure different from those in the other parts is formed only in a part of a metal member to which capacitor elements are connected, typically a lead frame. This structure can be achieved by applying a temporary masking means arbitrarily selected, for example, taping, to parts as desired. That is, a lead frame constituting the first and second metal members is prepared, and after in the portion connecting with the cathode part corresponding to the second metal member, taping is applied at least in the vicinity of the position at which the metal member is led out of the resin and then low-melting-point-metal plating is conducted, taping is removed. There is no limitation on the method for applying such a low-melting-point-metal plating. It is preferable to prepare a lead frame with taping and use stripe-plating method to thereby apply the plating only to portions requiring the plating.

### BEST MODE FOR CARRYING OUT THE INVENTION

The present invention is described in greater detail by referring to Examples. However, the present invention is not limited to these Examples.

### Example 1

A single plate capacitor element (8) shown in FIG. 1 was produced as follows. An etched aluminum foil (valve-action metal) having a thickness of 90 μm, a length of 5 mm and a width of 3 mm with an alumina dielectric film on the surface was used as a substrate (1). One end part of 3 mm in width×2 mm in length of the substrate was adopted as an anode (6) and the remaining portion of 3 mm in width×3 mm in length of the substrate was immersed in an aqueous 10% by mass ammonium adipate solution and electrochemical formation was performed by applying a voltage of 4 V to form a dielectric oxide film layer (2) on cut surfaces of the substrate to serve as a dielectric body. The surface of the dielectric body was impregnated with an aqueous solution prepared to contain 20% by mass of ammonium persulfate and 0.1% by mass of sodium anthraquinone-2-sulfonate and then, the substrate was immersed in 1.2 mol/l isopropanol solution containing 5 g of 3,4-ethylenedioxythiophene dissolved therein. The substrate was pulled up from the solution and left standing in an environment at 60° C. for 10 minutes to thereby complete oxidation polymerization, and then washed with water. The steps of polymerization reaction treatment and washing were repeated 10 times, to thereby form a solid electrolyte layer (4) comprising an electroconductive polymer. Subsequently, the substrate was immersed in a carbon paste tank and an electroconductive layer (5a) was formed by solidification of the carbon paste. Furthermore, the substrate was immersed in a silver paste tank and an electroconductive layer (5b) was formed by solidification of the silver paste. The operations were repeated, to thereby make the thickness of the electroconductive layer (5) become gradually larger toward the end part of cathode part. Thus, a single plate capacitor element (8) whose end of the cathode part was slightly thicker was obtained.

Subsequently, a piece having a shape of a lead frame was punched out from a copper substrate having a thickness of 0.1 mm with a press machine as shown in FIG. 8. On the surface of the lead frame, a nickel base plating was provided and then a tin-plating was provided thereon. In a resin-encapsulated part (20), however, tin plating was not provided on portions (21) and (22) contacting with molding resin (28), whereas the above plating treatment was provided only on portion (23) (an island part at the anode side of the lead frame, having a distance from the cathode side end) and portion (24) (an island part at the cathode side of the lead frame, having a distance from the anode side end) which closely contacted with a capacitor element.

In the plating treatment, the lead flame (10) (11), except portions (23) and (24) contacting with solid electrolytic capacitor element (26) encapsulated with resin (28), was masked by taping, whereby stripe plating was provided.

Three sheets of the single plate capacitor element (8) were stacked on the plated portions in the resin-encapsulated portion (20). Anode parts (6) of the single plate capacitor elements (8) were aligned to the left in FIG. 1, while cathode parts (7) of the single plate capacitor elements (8) were aligned to the right in FIG. 1. Each gap between the stacked cathode parts (7) and between the cathode part (7) and the lead frame (11) was bonded with a conductive paste (9), to thereby complete a laminated body consisting of the single plate capacitor elements (8) which was thicker toward the end. A stacked-type capacitor element (26) as shown in FIG. 12 was obtained by bonding anode parts with each other and one surface (23) of the lead frame (10) with the rear surface of anode part (6) by spot-welding, while bending the anode parts (6). As shown in FIGS. 12 and 13, the whole stacked capacitor element (26) was formed by molding with an epoxy resin (28). Then, burrs of the resin generated during the molding process were removed by shot blasting method with resin beads. The capacitor element encapsulated with the resin was separated from the lead frame and the lead was bended into a predetermined shape as shown in FIG. 12. In this manner, 50 units of solid electrolytic capacitor (29) were obtained.

### Example 2

### Comparative Examples 1 and 2

A capacitor element (8) was manufactured in the same manner as in Example 1. A lead frame was punched out from a copper substrate having a thickness of 0.1 mm with a press machine as shown in FIG. 9. On the surface of the lead frame, nickel base plating (0.1 μm in thickness) was provided and then tin plating (6 μm in thickness) was provided thereon. In a resin-encapsulated part (20), however, the tin plating was provided except on portions (21′) and (25′) contacting with molding resin (28), whereas the above plating treatment was provided on portions (23′) (an end part of the anode side facing the cathode) and (24′), each of which portions included a surface tightly contacting with a capacitor element. In this plating treatment, the lead flame (10) (11), except portions (23′) and (24′) which contacted with the resin(28)-encapsulated solid electrolytic capacitor element (26), was masked by taping, whereby stripe plating was provided.

By using the above lead flame, 50 units of solid electrolytic capacitor were obtained exactly in the same manner as in Example 1.

FIG. 15 (A) and (B) show results of moisture resistance tests (60° C., 95% RH) where leakage current values (LC; μA), capacitance values (CAP; μF), dielectric loss values (DF; %) and equivalent series resistance values (ESR; mΩ) were measured with time on reference solid electrolytic capacitors (Comparative Example 1) using a lead flame (reference LF) obtained without masking with tape and on solid electrolytic capacitors of the present invention using a lead flame (stripe-plated LF) obtained by masking with tape, respectively. In the results of measurements after hour 2000 on reference samples obtained without masking with tape, the values of capacitance (CAP) and dielectric loss (DF) showed increases. This indicates that moisture intruded into the resin, which increased the leakage current (LC). On the other hand, in the results of measurements after hour 2000 on samples obtained by masking with tape, intrusion of moisture into the resin was suppressed, which could control the increase of the leakage current (LC) to one-tenth as compared with that of reference samples. This evidences that the present invention has an effect of enhanced moisture resistance.

Furthermore, as Comparative Example 2, 20 units of capacitor were obtained in the same manner as in Example 1, except that a lead flame (reference LF) obtained without masking with tape was used. The moisture resistance tests for the capacitors in Example 2 and Comparative Example 2 were conducted, and leakage current (LC) values of the samples after 1000 hours were measured. Samples having a leakage current (LC) of 0.3 CV or more were evaluated as defective, the number of which was counted. The results are shown in Table 1.

TABLE 1

| | Defective units |
|---|---|
| Example 1 | 2/50 |
| Example 2 | 0/20 |
| Comparative Example 2 | 10/50 |

### Example 3

### Comparative Example 3

Niobium powder (about 0.1 g) was placed in an hopper, a tantalum device automatic molding machine (TAP-2R manufactured by SEIKEN CO., LTD.) and molded automatically together with a niobium wire having a diameter of 0.28 mmΦ, to thereby produce a molded body having a size of 4.4 mm×3.0 mm×1.8 mm. The molded body was left standing under reduced pressure of 4×10⁻³ Pa at a voltage of 1250 V for 30 minutes to thereby obtain a sintered body. In this way, 60 units of such a sintered body were prepared for each of Example 3 and Comparative Example 3 and subjected to electrolytic formation at a voltage of 12 V for 360 minutes in an aqueous solution of 10% by mass phosphoric acid, to thereby form a dielectric oxide film on surface of the sintered bodies. Next, an operation where after the dioxide film was allowed to contact with the dielectric oxide film layer with a mixed solution containing the same amount of 12% by mass ammonium persulfate aqueous solution and 0.5% by mass anthraquinone sulfonic acid aqueous solution, the dielectric oxide film was further allowed to contact with pyrrole vapor, was repeated 12 times to thereby form an electrode couple (counter electrode) comprising a polypyrrole. The sintered bodies were washed for 30 minutes in deionized water and dried at 105° C. for 30 minutes. After that, the sintered bodies were subjected to chemical reformation at a voltage of 8 V for 30 minutes in an aqueous solution of 1.0% by mass phosphoric acid.

The sintered bodies were washed for 30 minutes in deionized water and then dried at 105° C. for 30 minutes. After immersion in carbon paste, the sintered bodies were subjected to drying at 80° C. for 30 minutes and 150° C. for 30 minutes. Subsequently, the sintered bodies were subjected to immersion in silver paste and drying at 80° C. for 30 minutes and 150° c. for 30 minutes, to thereby produce capacitor elements. On a lead frame which had been stripe-plated in the same manner as in Example 1, (with its cathode part having been subjected to bending treatment,) and on a reference lead frame produced in Comparative Example 1, (with its cathode part having been subjected to bending treatment,) the elements were stacked and bonded to each other by using silver paste. After bonding the anode part of the element to the lead frame respectively, each of the whole body of the stacked elements was encapsulated with an epoxy resin. Each was aged at rated voltage at 120° C. for 3 hours, to thereby produce 30 units of the solid electrolytic capacitors for each of Example 1 and Comparative Example 1, that is, 60 units in total. Moisture resistance test was conducted by the same manner as in Example 1 using the obtained capacitors. Leakage current (LC) values after 500 hours were measured and samples having a leakage current (LC) of 0.3 CV or more were evaluated as defective, the number of which was counted, in the same manner as in Example 2. The results are shown in Table 2.

TABLE 2

| | Defective |
|---|---|
| | fraction |
| Example 3 | 1/30 |
| Comparative Example 2 | 5/30 |

### Example 4

### Comparative Example 4

Total 60 units of capacitor element were prepared to produce 30 units of capacitors for each of Example 4 and Comparative Example 4 by using the elements in the same manner as in Example 3, except that as the lead frames, the same stripe-plated lead frame as used in Example 2 (with its cathode part having been subjected to bending treatment) was used and the reference lead frame (with its cathode part having been subjected to bending treatment) was used. Moisture resistance test was conducted by the same manner as in Example 3 using the obtained capacitors. Leakage current (LC) values after 500 hours were measured and samples having a leakage current (LC) of 0.3 CV or more were evaluated as defective, the number of which was counted, in the same manner as in Example 3. The results are shown in Table 3.

TABLE 3

| | Defective units |
|---|---|
| Example 4 | 1/30 |
| Comparative Example 4 | 6/30 |

### Comparative Example 5

On portion (23) of the lead frame in Example 1, only nickel base plating (0.1 μm in thickness) was provided and thus a lead frame without low melting point plating was prepared. An attempt to conduct resistance welding on the anode part was made, but only unsuccessfully. Although a trace of contact with the electrode was observed, it was hard to weld a formed aluminum foil to the anode part.

### Examples 5 and 6

### Comparative Examples 6 and 7

Each capacitor element was produced as follows.

On a 100-μm thick formed aluminum foil (manufactured by JAPAN CAPACITOR INDUSTRIAL CO., LTD., foil type: 110LJB22B11VF; hereinafter referred to as formed foil) of 3 mm in short axis direction and 10 mm in long axis direction, a 1 mm-wide masking material of heat resistant resin was applied in a belt-like manner, to thereby divide the foil into cathode part (7) and anode part (6). The cathode part (7), which was a distal section of the formed foil, was subjected to chemical formation treatment using an aqueous solution of ammonium adipate serving as an electrolyte solution, followed by washing with water. Next, the cathode part (7) was immersed in 1 mol/liter isopropyl alcohol solution containing 3,4-ethylenedioxythiophene, and then left standing for 2 minutes. Subsequently, the cathode part (7) was immersed in a mixed aqueous solution of an oxidant (1.5 mol/liter ammonium persulfate) and a dopant (0.15 mol/liter sodium-2-naphthalene sulfonate), and left standing in the solution at 45° C. for 5 minutes, to thereby cause oxidation polymerization. This operation including immersion and polymerization processes was repeated 12 times in total, whereby a solid electrolyte layer comprising the dopant was formed in the inside of fine pores of the formed foil. The formed foil having the solid electrolyte layer comprising the dopant formed thereon was washed with hot water of 50° C. to form a solid electrolyte layer. After that, the foil with the solid electrolyte layer was washed with water and dried at 100° C. for 30 minutes. The solid electrolyte layer was coated with carbon paste and then with silver paste, to thereby obtain an element (8).

4 sheets of thus obtained element were stacked on each lead flame described below and each of the whole body was encapsulated with an epoxy resin (manufactured by HENKEL corporation, MG33F-0593), to be a sample.

A lead frame of a 100 μm-thick copper plate of CDA (Copper Development Association, USA) standard No. 194000), all (both) surfaces of which plate had been plated with nickel in thickness of 0.5 to 1.5 μm per one surface and then surfaces excluding a predetermined part of which plate had been plated with tin in thickness of 5 to 7-μm per one surface, was used as shown in FIG. 10, except for Sample 1. The excluded part (25) for each sample was as follows.
Sample 1 (Comparative Example 6):
All portions contacting with the capacitor element (i.e., the lead frame was made of copper base material without plating)
Sample 2(Example 5): A (belt-like) portion 1 mm (t′=1 mm) from the leading-out part on the cathode side
Sample 3(Example 6): A (belt-like) portion 0.67 (t′=0.67 mm) from the leading-out part on the cathode side
Sample 4(Comparative Example 7): No portion was excluded (t′=0).

Evaluation on properties of each sample was conducted at 262° C. for 10 seconds without forming after undergoing a screening process. As a result, in Sample 4, solder balls were observed in 27 out of the total 32 units (by visual inspection). Meanwhile in Samples 1 to 3, no solder balls were observed in 32 units of each Sample (by visual inspection).

The results of electric properties are shown in Table 4.

TABLE 4

| | Initial | Initial | ESR after | Solder |
|---|---|---|---|---|
| | ESR | LC | reflow | ball |
| | (mΩ) | (μA) | (mΩ) | generation |
| Comparative | 7.0 | 0.873 | 6.8 | 0/32 |
| Example 6 | | | | |
| Example 5 | 6.0 | 0.981 | 6.2 | 0/32 |
| Example 6 | 6.0 | 0.857 | 6.2 | 0/32 |
| Comparative | 5.4 | 0.896 | 6.8 | 27/32 |
| Example 7 | | | | |

As shown in Table 4, in Examples 4 and 5 of the present invention where the portion free of low-melting-point plating was provided in vicinity of the portion at which a conductor led out, neither generation of solder balls nor significant degradation of electric properties after reflow process was observed.

### Examples 7 and 8

### Comparative Example 8

Capacitors were produced in the same manner as in Example 5, except that the lead flame used here was different in plating pattern on the anode side as shown in FIG. 11 from that of Example 5. Theses Examples are different from Example 5 in that in resin-encapsulated part (20), tin plating was not applied on portion (21′) contacting with molding resin (28). The part free of tin plating on the cathode part for each sample was as follows.
Sample 5 (Example 7): A (belt-like) portion 1 mm from the leading-out part of the cathode side
Sample 6 (Example 8): A (belt-like) portion 0.67 mm from leading part of cathode side
Sample 7(Comparative Example 8): No portion was free of tin plating.

Properties of each sample and generation of solder balls were evaluated in the same manner as in Example 5.

TABLE 5

| | Initial | Initial | ESR after | Solder |
|---|---|---|---|---|
| | ESR | LC | reflow | ball |
| | (mΩ) | (μA) | (mΩ) | generation |
| Example 7 | 6.2 | 0.85 | 6.4 | 0/32 |
| Example 8 | 6.5 | 0.80 | 6.6 | 0/32 |
| Comparative | 6.3 | 0.82 | 6.5 | 25/32 |
| Example 8 | | | | |

### INDUSTRIAL APPLICABILITY

The solid electrolytic capacitor of the present invention, with a structure as described above, has excellent effects as follows.

(a) A solid electrolytic capacitor, free of gaps generated by thermofusion in the resin encapsulation, excellent in moisture resistance and having high reliability, is obtained. Its industrial-scale production is easy.
(b) A capacitor element can be bonded to a lead frame by resistance welding and therefore, a solid electrolytic capacitor obtained by encapsulation the capacitor element with resin has an excellent heat resistance and moisture resistance because of high degree of completion of the resin encapsulation.
(c) A lead frame plated with low-melting-point metal can be used, so that no additional plating process is required. In the case of resistance welding, it is easy to conduct anodic bonding in stacking elements.
(d) Since low-melting-point plating is provided only on parts of the lead frame which contact with a capacitor element so as to prevent bonding defects caused by solder balls or the like in the resin encapsulated part, a solid electrolytic capacitor having good stability in bonding between a capacitor element and a lead frame and high reliability can be obtained.
(e) A valve action metal foil (sheet) of a capacitor element can be bonded to anode side of a lead frame easily and tightly by resistance welding. Accordingly, a stack of capacitor elements and a solid electrolytic capacitor using the stacked elements can be manufactured in economically advantageous manner. Especially, a lead frame consisting of a material having good electrical conductivity such as copper and copper compound, and a substrate such as formed aluminum foil can be bonded to each other with high reliability, which makes the capacitor highly useful. Furthermore, the capacitor includes no plating material containing lead, lead compound or the like and therefore it involves no environmental problems.
(f) When a capacitor element is stacked and bonded onto a lead frame, the cathode side edge of the lead frame is not allowed to be present close to the insulating layer of the capacitor element and the element is placed at a position where the insulating layer can be present with a certain distance from the cathode side edge of the lead frame. The cathode edge is chamfered. By these technical features, a capacitor having a god heat resistance can be obtained at high yield. Moreover, in a case where a lead frame has no window part, a remarkable effect of suppressing resistance of the lead frame is achieved. Furthermore, in a case where a lead flame with a mark showing a position for bonding a capacitor element provided thereon by half-etching or the like is used, positioning of a capacitor to be stacked on the lead frame can be achieved accurately and easily.

### BRIEF DESCRIPTION OF THE DRAWINGS

FIG. 1 shows one example of a cross-sectional view of the structure of a single capacitor element used in the present invention.

FIG. 2 (A) shows one example of a cross-sectional view of stacked capacitor elements in the present invention.

FIG. 2 (B) shows one example of enlarged view showing vicinity of cathode side edge (A) of the lead frame.

FIG. 3 is one example of a cross-sectional view of a capacitor element in which a lead frame is placed at a position of 0 mm (t=0).

FIG. 4 (A) shows one example of a side view of a lead frame of the present invention. FIG. 4 (B) is a plain view of the lead frame.

FIG. 5 shows one example of a plain view of a lead frame with window parts.

FIG. 6 shows one example of a cross-sectional view of a stacked-type capacitor element of the present invention.

FIG. 7 shows one example of a chart showing a pattern of impressed current in resistance welding of the present invention.

FIG. 8 shows a partial plain view of a lead frame with partial plating according to the present invention (Example 1).

FIG. 9 shows a partial plain view of a lead frame with partial plating according to the present invention (Example 2).

FIG. 10 shows a partial plain view of a lead frame with partial plating according to the present invention (Example 5).

FIG. 11 shows a partial plain view of a lead frame with partial plating according to the present invention (Example 7).

FIG. 12 shows one example of a cross-sectional view of a stacked-type capacitor element of the present invention.

FIG. 13 shows one example of a partial plain view of a stacked-type capacitor element molded with resin according to the present invention.

FIG. 14 shows one example of a cross-sectional view of a stacked-type solid electrolytic capacitor of the present invention.

FIG. 15 (A) shows charts resulting from comparative moisture resistance test on reference samples. FIG. 15 (B) shows charts resulting from moisture resistance test on samples of the present invention (with stripe plated LF).

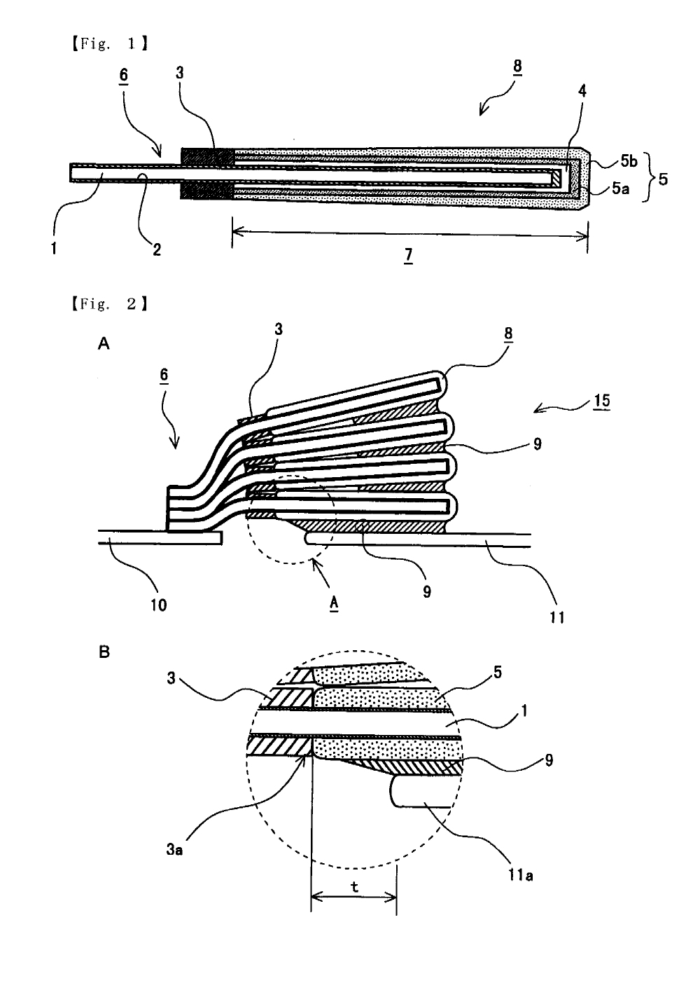

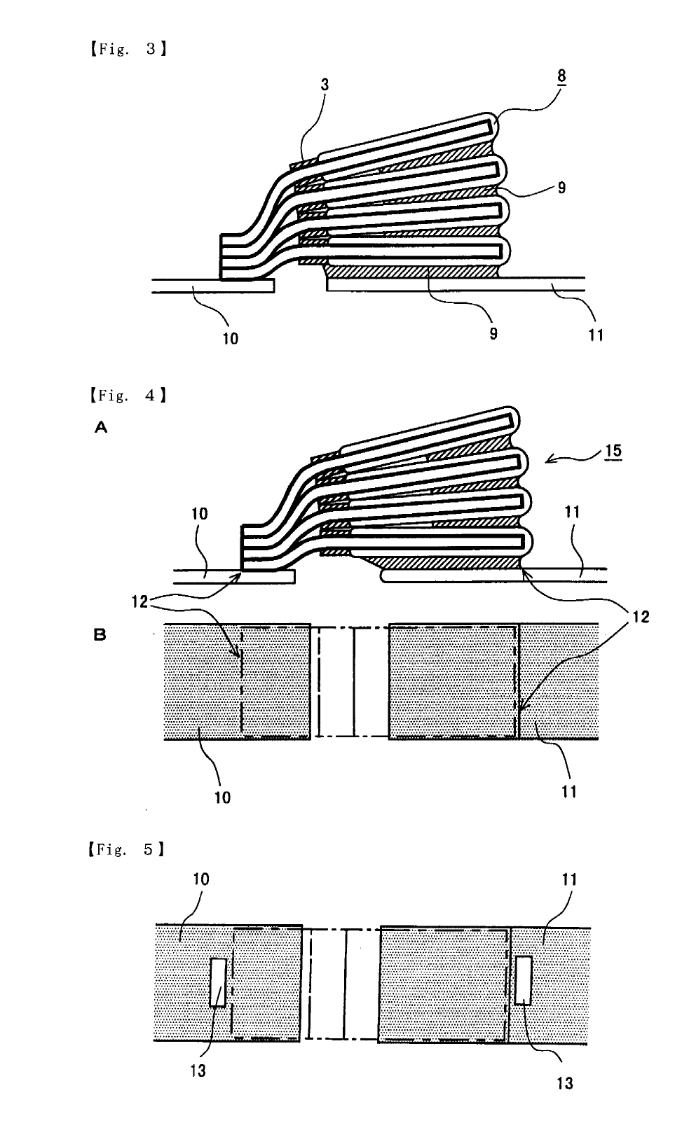

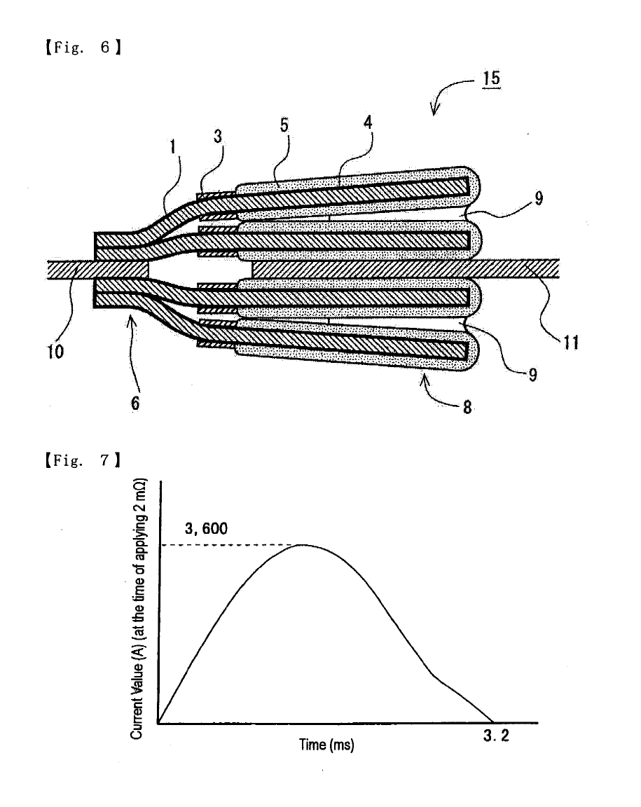

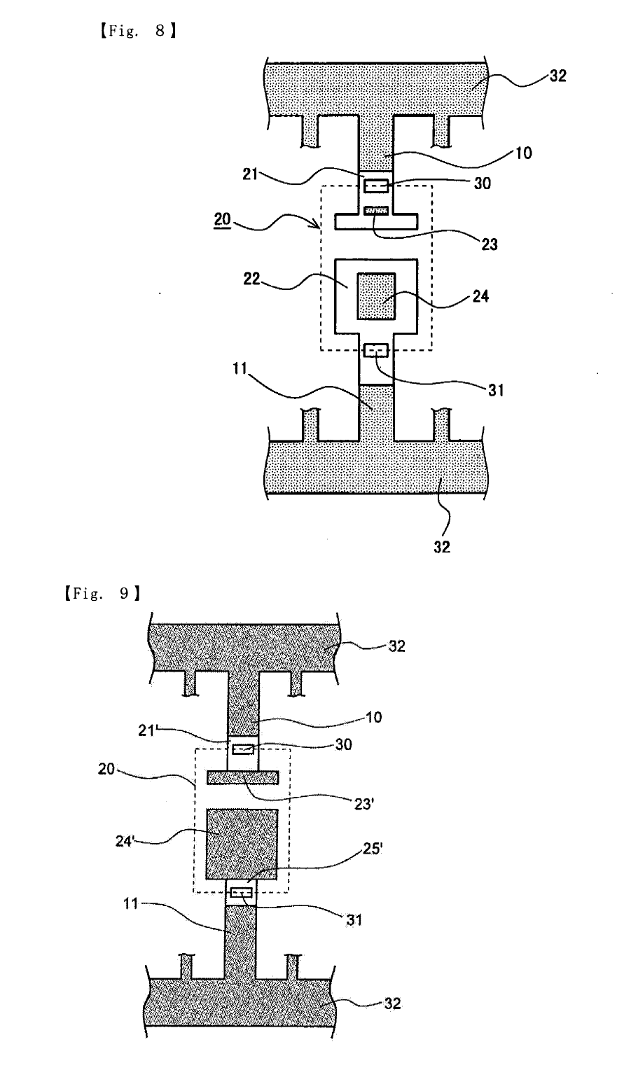

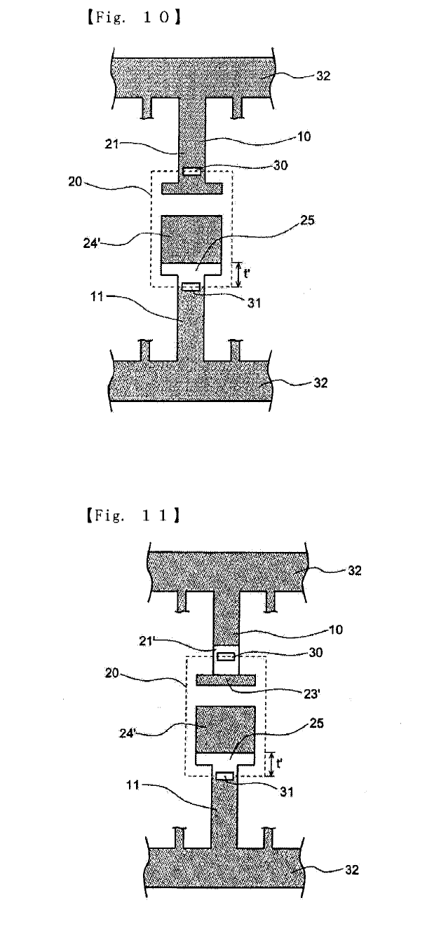

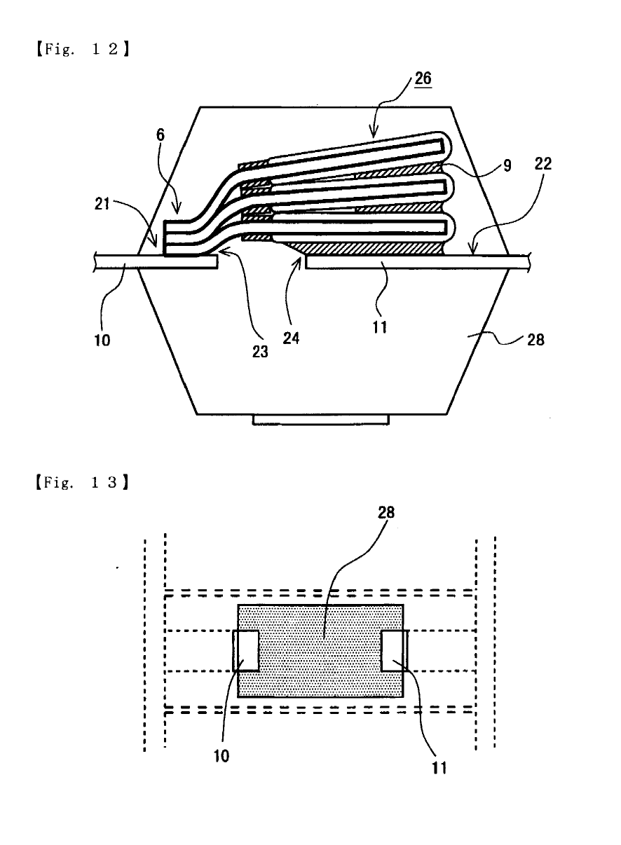

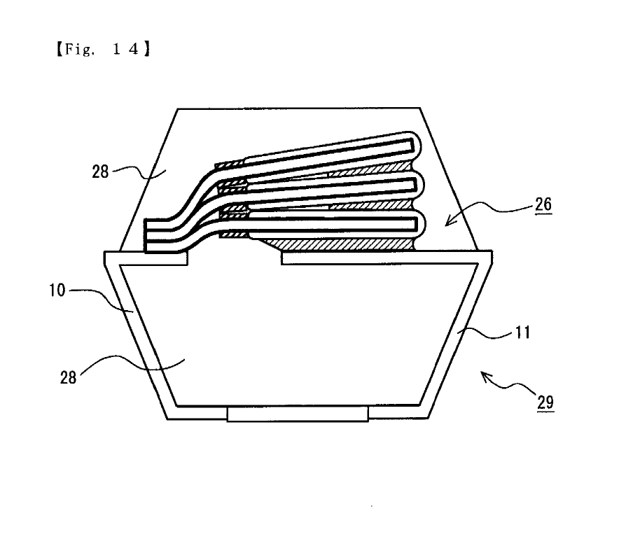

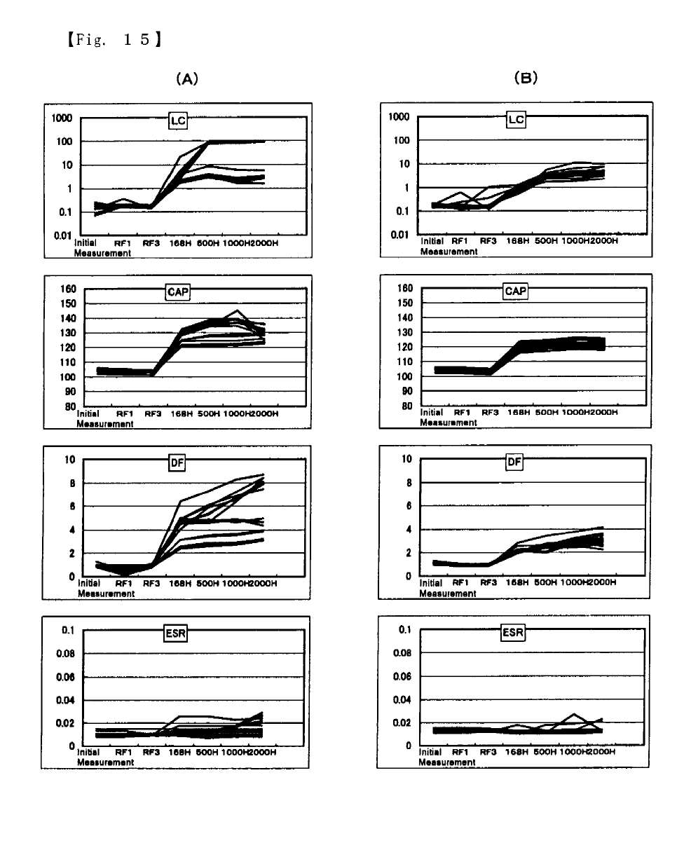

### DESCRIPTION OF REFERENCE NUMERALS

1 substrate
2 dielectric film layer
3 insulating layer
3a end part of insulating layer in the cathode direction
4 solid electrolyte layer
5 electroconductive layer
5a carbon paste
5b silver paste
6 anode part
7 cathode part
8 capacitor element
9 electroconductive paste
10 lead flame
11 lead flame
11a lead flame edge
12 mark indicating a position for bonding
13 window part
15 capacitor element
20 resin-encapsulated part
21 lead flame surface (anode part) contacting with molding resin
21′ part free of low-melting-point plating
22 lead flame surface (cathode part) contacting with molding resin
23 part of lead frame contacting with capacitor element
23′ part of lead frame including a surface contacting with capacitor element
24 part of lead frame contacting with capacitor element
24′ part of lead frame including a surface contacting with capacitor element
25 part free of low-melting-point plating
26 capacitor element
28 molding resin
29 stacked-type solid electrolytic capacitor
30 window part
31 window part
32 part of lead flame out of resin

1. A solid electrolytic capacitor, which is obtained by bonding an anode part of a capacitor having the anode part and a cathode part separated from each other by an insulating layer present therebetween to a first metal member, bonding the cathode part to a second metal member and then encapsulating the whole with resin, with each of the metal members being exposed in part, wherein the first and/or the second metal members have a region containing a plating layer of low melting point metal and a region not containing a plating layer of low-melting-point metal according to a predetermined patterning.

2. The solid electrolytic capacitor according to claim 1, comprising a capacitor element (8) or a stack of capacitor elements (15) each having a structure in which: one end of a substrate (1) made of a valve-action metal having a dielectric film layer (2) serves as an anode part (6); an insulating layer (3) of a predetermined width bordering on the anode part is provided on the substrate (1) in a belt-like manner to serve as an insulator; and a solid electrolyte layer (4) and an electroconductive layer (5) to serve as a cathode part (7) are stacked sequentially on the dielectric film layer except on the area of the anode part (6) and the insulator, which capacitor element(s) contacts with the lead frame (10) (11), wherein by applying a belt-like masking to the lead frame (10) (11) except for portion (23) or except for portions (23) and (24) which contact with capacitor elements, the lead frame (10) (11) contacting with the resin (28) are not plated with metal having a low melting point while only the portion (23) or the portions (23) and (24) of the lead frame (10) (11) are plated with metal having a low melting point, and wherein the lead frame (10) (11) is bonded to the anode part (6) and the cathode part (7) of the capacitor element(s)(8) or (15) and the whole is encapsulated with the resin (28).

3. The solid electrolytic capacitor according to claim 2, wherein the anode part (6) of the capacitor element(s) (8) or (15) is superposed on the low-melting-point-metal plating on the surface (23) of the lead frame (10) on the anode side and then resistance-welded to be bonded through resistance heat of the dielectric film.

4. The solid electrolytic capacitor according to claim 2, wherein in bonding the capacitor element(s)(8) or (15) to the portions (23) and (24) of the lead frame (10) (11), the anode part (6) of the capacitor element(s)(8) or (15) is superposed on the low-melting-point-metal plating on the portion (23) of the lead frame (10) on the anode side and is resistance-welded while the bonding of the cathode side is carried out with a distance (t) being provided between the end part (3a) of the insulating layer (3) on the cathode side of the capacitor element(s) (8) or (15) and the edge (11a) on the cathode side of the lead frame.

5. The solid electrolytic capacitor according to claim 1, comprising a capacitor element (8) or a stack of capacitor elements (15) each having a structure in which: one end of a substrate (1) made of a valve-action metal having a dielectric film layer (2) serves as an anode part (6); an insulating layer (3) of a predetermined width bordering on the anode part is provided on the substrate (1) in a belt-like manner to serve as an insulator; and a solid electrolyte layer (4) and an electroconductive layer (5) to serve as a cathode part (7) are stacked sequentially on the dielectric film layer except on the area of the anode part (6) and the insulator, which capacitor element(s) contacts with the lead frame (10) (11), wherein by applying a belt-like masking to the lead frame (10) (11) except for portion (23′) or except for portions (23′) and (24′) which contact with capacitor elements, the lead frame (10) (11) contacting with the resin (28) are not plated with metal having a low melting point while only the portion (23′) or the portions (23′) and (24′) of the lead frame (10) (11) are plated with metal having a low melting point, and wherein the lead frame (10) (11) is bonded to the anode part (6) and the cathode part (7) of the capacitor element(s)(8) or (15) and the whole is encapsulated with the resin (28).

6. The solid electrolytic capacitor according to claim 5, wherein the anode part (6) of the capacitor element(s) (8) or (15) is superposed on the low-melting-point-metal plating on the surface (23′) of the lead frame (10) on the anode side and then resistance-welded to be bonded through resistance heat of the dielectric film.

7. The solid electrolytic capacitor according to claim 5, wherein in bonding the capacitor element(s) (8) or (15) to the portions (23′) and (24′) of the lead frame (10) (11), the anode part of the capacitor element(s) (8) or (15) is superposed on the low-melting-point-metal plating on the portion (23′) of the lead frame (10) on the anode side and is resistance-welded while the bonding of the cathode side is carried out with a distance (t) being provided between the end part (3a) of the insulating layer (3) on the cathode side of the capacitor element(s) (8) or (15) and the edge (11a) on the cathode side of the lead frame

8. A solid electrolytic, which is obtained by bonding an anode part of a capacitor having the anode part and a cathode part separated from each other by an insulating layer present therebetween to a first metal member, bonding the cathode part to a second metal member and then encapsulating the whole with resin with each of the metal members being exposed in part, wherein the portion of the second metal member bonding to the cathode part has a region containing a plating layer of low melting point metal and a region not containing a plating layer of low melting point metal, and the region not containing a low-melting-point-metal plating layer is a portion bonding to the cathode part ncar the position at which the second metal material is led out of the encapsulating resin.

9. The solid electrolytic capacitor according to claim 8, wherein part of the cathode part is superposed on and bonded to the second metal member to be electrically conducting to each other.

10. The solid electrolytic capacitor according to claim 8, comprising a capacitor element having an insulating layer of metal oxide, a solid electrolyte layer and an electroconductive paste layer sequentially formed at least on a part of the valve-action metal surface having a porous layer on the surface, wherein the exposed part of the valve-action metal serves as an anode part and the electroconductive paste layer serves as a cathode part.

11. The solid electrolytic capacitor according to claim 1, wherein the valve-action metal is selected from a group consisting of aluminum, tantalum, titanium, niobium and alloys thereof.

12. The solid electrolytic capacitor according to claim 1, wherein the lead frame (10) (11) consist of copper or a copper alloy (copper-based material) or a material having plating of a copper-based material or zinc-based material.

13. The solid electrolytic capacitor according to claim 1, wherein the low-melting-point-metal plating consists of a metal or an alloy having a melting point lower than that of the valve-action metal and the thickness of the plating is within 0.1 to 100 μm.

14. The solid electrolytic capacitor according to claim 1, wherein the low-melting-point-metal plating consists of a base plating of nickel and a surface plating of tin.

15. The solid electrolytic capacitor according to claim 1, wherein the position of bonding the lead frame (10) (11) is in the middle part or periphery of the stacked capacitor elements.

16. A method for producing a solid electrolytic capacitor, comprising a step of providing an insulating layer (3) of a predetermined width in a belt like manner bordering an anode part (6) which is one end part of a valve-action metal substrate (1) having a dielectric film layer (2), a step of forming a single capacitor element (8) by providing a solid electrolyte layer (4) on the dielectric film layer except on the area of the anode part (6) and the insulating part and further stacking an electroconductive layer (5) thereon to be a cathode part (7) or forming a stack of two or more of the thus obtained capacitor elements (15), a step of bonding a lead frame (10) (11) to the anode part (6) and the cathode part (7) of capacitor element(s)(8) (15) after applying a belt-like masking onto the lead frame (10) (11) except for the portion (23) or except for portions (23) and (24) which contact with the capacitor element(s)(8) (15) so that in the part (20) encapsulated with resin, low-melting-point-metal plating is not provided on portions of the lead frame (10) (11) which contact with the resin (28) while low-melting-point-metal plating is provided on the portion (23) or portions (23) and (24), and a step of encapsulating the whole with resin.

17. A lead frame (10) (11), which is bonded to an anode part (6) and cathode part (7) of capacitor element(s)(8) (15) obtained by a step of providing an insulating layer (3) of a predetermined width in a belt like manner bordering an anode part (6) which is one end part of a valve-action metal substrate (1) having a dielectric film layer (2), wherein in the lead frame, a belt-like masking is applied except for the portion (23) or except for portions (23) and (24) which contact with the capacitor element (8) or stacked capacitor elements (15) each having a cathode part (7) consisting of a solid electrolyte layer (4) and an electrically conductive layer (5) stacked sequentially on the dielectric film layer of the region excluding the anode part and insulating part, so that in the part (20) encapsulated with resin (28), low-melting-point-metal plating is not provided on portions of the lead frame (10) (11) which contact with the resin (28) while low-melting-point-metal plating is provided only on the portion (23) or portions (23) and (24).

18. The lead frame (10) (11) according to claim 17, wherein the lead frame bonded to the anode part (6) and the cathode part (7) of the capacitor element(s)(8) (15) encapsulated with the resin (28) comprises a material of copper or a copper alloy (copper-based material) or a material plated with a copper-based material or zinc-based material on the surface.

19. A method for producing a solid electrolytic capacitor, comprising a step of providing an insulating layer (3) of a predetermined width in a belt like manner bordering an anode part (6) which is one end part of a valve-action metal substrate (1) having a dielectric film layer (2), a step of forming a single capacitor element (8) by providing a solid electrolyte layer (4) on the dielectric film layer except on the area of the anode part (6) and the insulating part and further stacking an electroconductive layer (5) thereon to be a cathode part (7) or forming a stack of two or more of the thus obtained capacitor elements (15), a step of bonding a lead frame (10) (11) to the anode part (6) and the cathode part (7) of capacitor element(s)(8) (15) after applying a belt-like masking onto the lead frame (10) (11) except for the portion (23′) or except for portions (23′) and (24′) which contact with the capacitor element(s) (8) (15) so that in the part (20) encapsulated with resin, low-melting-point-metal plating is not provided on portions of the lead frame (10) (11) which contact with the resin (28) while low-melting-point-metal plating is provided only on the portion (23′) or portions (23′) and (24′), and a step of encapsulating the whole with resin.

20. A lead frame (10) (11), which is bonded to an anode part (6) and cathode part (7) of capacitor element(s) (8) (15) obtained by a step of providing an insulating layer (3) of a predetermined width in a belt like manner bordering an anode part (6) which is one end part of a valve-action metal substrate (1) having a dielectric film layer (2), wherein in the lead frame, a belt-like masking is applied except for the portion (23′) or except for portions (23′) and (24′) which contact with the capacitor element (8) or stacked capacitor elements (15) each having a cathode part (7) consisting of a solid electrolyte layer (4) and an electrically conductive layer (5) stacked sequentially on the dielectric film layer of the region excluding the anode part (6) and insulating part, so that in the part (20′) encapsulated with resin (28), low-melting-point-metal plating is not provided on portions of the lead frame (10) (11) which contact with the resin (28) while low-melting-point-metal plating is provided only on the portion (23′) or portions (23′) and (24′).

21. The lead frame (10) (11) according to claim 20, wherein the lead frame bonded to the anode part (6) and the cathode part (7) of the capacitor element(s) (8) (l5) encapsulated with the resin (28) comprises a material of copper or a copper alloy (copper-based material) or a material plated with a copper-based material or zinc-based material on the surface.

22. A method for producing a solid electrolytic capacitor, comprising a step of applying a temporary masking on part of the lead frame consisting of a first metal member and a second metal member, at least onto an area of close to the position at which the metal member is led out of resin encapsulation in the bonding portion between the second metal member and the cathode part, a step of plating the lead frame with a low melting point metal, a step of removing the temporary masking, a step of placing and bonding the anode part and the cathode part of the capacitor element onto each of the first and the second metals and bonding, and then a step of encapsulating the whole with resin.

23. The method for producing a solid electrolytic capacitor according to claim 22, wherein the temporary masking is in form of belt.

24. The method for producing a solid electrolytic capacitor according to claim 22, wherein the capacitor element consists of an insulating layer of metal oxide, a solid electrolyte layer and an electrocunductive paste layer sequentially formed at least on part of a valve-action metal surface having a porous layer on the surface, the exposed portion of the valve-action metal serving as an anode part and the electroconductive paste layer serving as the cathode part.
